(19) United States
(12) Patent Application Publication
(10) Pub. No.: US 2003/0042349 A1
(43) Pub. Date: Mar. 6, 2003

(54) Breaking structure of measuring tape

(75) Inventor: Henry Lin, Taipei (TW)

Correspondence Address: DOUGHERTY & TROXELL, ONE SKYLINE PLACE, 5205 LEESBURG PIKE, SUITE 1404, FALLS CHURCH, VA, 22041, US

(73) Assignee: INDEX MEASURING TAPE CO., LTD.

(21) Appl. No.: 09/916,430

(22) Filed: Jul. 30, 2001

(51) Int. Cl. B65H 75/30; B65H 75/48; G01B 3/10

(52) U.S. Cl. 242/381.3; 33/767

(57) ABSTRACT

A breaking structure of measuring tape, including a housing, a tape rule contained in the housing and a braking mechanism, characterized in that: a push button is formed onto the housing, by pushing the push button into the housing to keep it at a lower position; a base stopper of the braking mechanism would effectively suspend the movement of the tape rule, and after that, if the push button is pushed downward again, the braking mechanism would push the push button upward and return to its higher position, then the base stopper of the braking mechanism would separate the tape rule and the movement of the tape rule would not be suspended.

### BACKGROUND OF THE INVENTION

1. Field of the Invention

The present invention relates to a braking structure of measuring tape, especially to a braking mechanism by which the movement of the rule would be effectively suspended, and the braking function of measuring tape is easily to be withdrawn.

2. Description of the Prior Art

As shown in FIG. 1A, the conventional measuring tape rule has a pushing key 101 above the housing, 100, the pushing key 101 is connected with a pressing leg 102 which is put inside the housing 100. When the pushing key 101 is pushed downward by the user, the pressing 102 would slide downward and its lower end would press the upper surface of tape rule 103, then the movement of tape rule 103 is suspended (as shown in FIG. 1B).

In using the above shown structure, since the movement of tape rule 103 is suspended when the pushing key 101 is pushed downward and the lower end of said pressing leg 102 is pressed against the upper surface of the tape rule 103, when the pushing force is withdrawn, the tape rule would be rewinded back into the housing immediately. It is then inconvenient for people to use.

FIG. 1C shows another prior art of measuring tape invented by the inventor. It is characterized in that, a pushing key 201 is installed onto an upper comer of the housing, said pushing key 201 can be rotated with a shaft 202 through the center of the lower end of said pushing key 201. Such that when one end of pushing key 201 is pushed downward, the pressing element 203 installed beneath the pushing key 201 would be pushed downward to press the tape rule 204, then if different end of the pushing key 201 is pressed, then the pressing force against tape rule is removed.

In using the measuring tape as shown in FIG. 1C, the movement of tape rule can be easily controlled. However, it is still necessary to install a pushing key onto the housing, then the beauty of a whole body and the comfort of holding the measuring tape are greatly reduced.

Furthermore, in order to suspend the movement of the tape rule, a pushing force which would overcome the force to rewind the tape rule should be performed. It is a hard work to people's thumb. Therefore, the conventional measuring tapes are not convenient for people's uses.

In addition, since the pushing key has to have the function of pushing the tape stopping element, the measuring tape together with its tape stopping element then has to occupy a relative volume to endure the stopping force performed onto the pushing key. It is then easy to cause injury to people.

In order to improve the aforementioned defects, the inventor of present invention has made a great effort and has made many novel designs.

### SUMMARY OF THE INVENTION

Accordingly, the object of the present invention is to provide a braking structure of a measuring tape which is actuated by a push button and a braking mechanism. Thus, the rule may conveniently and effectively be controlled.

Another object of the present invention is in that the push button can be formed by the cover of the housing, such that it is not necessary to install a big pushing key onto the housing, then the outline of housing can be maintained and the braking is much easier to control.

A Another object of the present invention is in that the push button can be pushed downward by the whole hand rather than by a single thumb, it is then much easier and convenient to people.

Since the outline of housing of the present invention can be maintained in smooth, it would not cause injury to people; it is then an additional object of the present invention.

The present invention will be better understood and its numerous objects and advantages will become apparent to those skilled in the art by referencing to the following drawings in which:

### BRIEF DESCRIPTION OF THE DRAWINGS

FIG. 1A is a cross-sectional view of a prior measuring tape.

FIG. 1B is a cross-sectional view of a prior measuring tape of FIG. 1A in using.

FIG. 1C is a cross-sectional view of another prior measuring tape.

FIG. 1D is a cross-sectional view of another prior measuring tape of FIG. 1C in using:.

FIG. 2 is a perspective view of the present invention FIG. 3 is a partial exploded view of the measuring tape according to the present invention.

FIG. 4 is a plane view showing the braking mechanism of present invention.

FIG. 5 is an enlarged plane view showing the heart-shaped furrow of present invention.

FIG. 6 is a side view showing the inner mechanism of present invention before braking is performed.

FIG. 7 is a side view showing the inner mechanism of present invention after braking is performed.

FIG. 8 is a side view showing the present invention is held by a person.

FIG. 9 is a second example of the second preferred embodiment of present invention.

FIG. 10 is a third example of the third preferred embodiment of present invention.

### DETAILED DESCRIPTION OF THE PREFERRED EMBODIMENTS

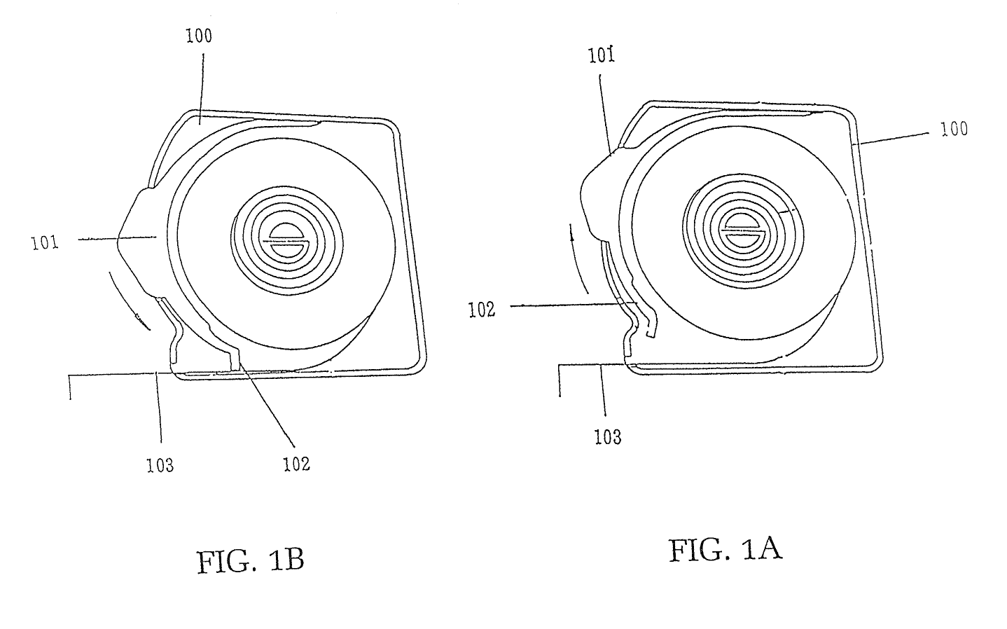

FIGS. 1A to 1D show the examples of conventional measuring tape; their functions and disadvantages are described as above; it is not repeated herewith.

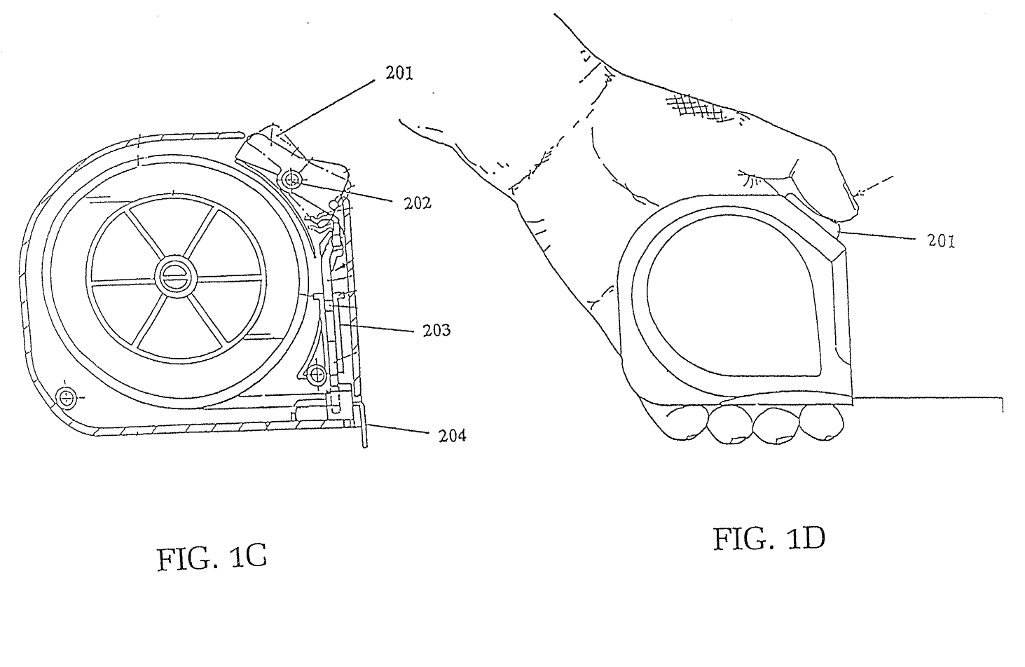

As shown in FIG. 2, the outer body of the measuring tape of present invention is composed by a housing 1 and an upper cover 2, the housing 1 is constructed by a left housing 11 and a right housing 12 to screw together; the upper cover 2 is formed a as push button.

As shown in FIG. 3, inside the housing 1, there is a tape rule 3 and a braking mechanism 4 is installed into a front space inside the housing 1. It is preferably to form a vertical furrow 13 for firmly holding the braking mechanism 4, so as to brake the tape rule below the brake mechanism 4.

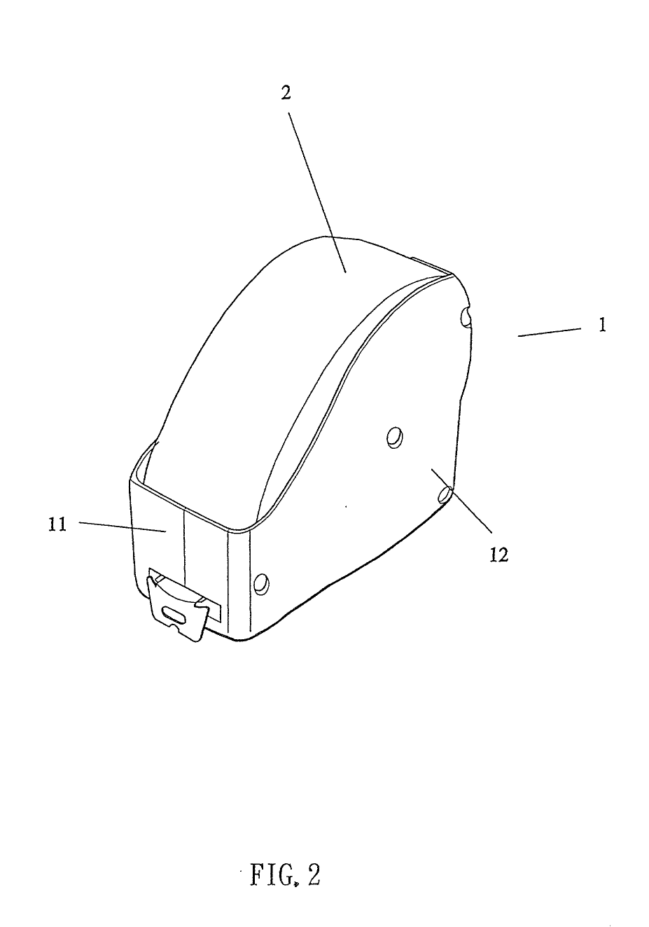

Please refer to FIG. 3 and FIG. 4, the braking mechanism 4 is composed of a stem 5 and a base 6, wherein the stem 5 is a long strip body, a vertical long-shaped furrow 51 is formed on the body of the stem 5, and under the long-shaped furrow 51, a heart-shaped furrow 52 is formed. Between the said long-shaped furrow 51 and said heart-shaped furrow 52, there is a “ [symbol] ” shaped hook 53 with its two free ends respectively insert into said long-shaped furrow 51 and said heart-shaped furrow 52. The upper section of hook 53 is held by a first spring 54 mounted onto the stem 5, and the upper end of the first spring 54 is stopped by two ears 55, 56 installed at the upper end of the stem 5. The ends of said ears 55, 56 are put into a pair furrows 21, 22 formed at the upper cover 2. Then, after the upper cover 2 is put inside the housing 1 with a pair of holes 23 formed at one end of the upper cover 2 to be mounted onto the short shaft 14 formed at the housing 1, then the upper cover 2 can be used as a push button to actuate the braking mechanism 4.

The lower end of said stem 5 is formed with a pressing plate 57; said pressing plate 57 is extruded into the inner space 61 of said base 6 to press the second spring 62 installed inside the base 6. When the stem 5 is pressed downward by said upper cover 2, then the second spring 62 inside the base 6 is depressed and then the base 6 moved downward to press against the upper surface of tape rule, then the movement of tape rule is suspended.

Again please refer to FIG. 3 and FIG. 4, said vertical space 13 formed inside the housing for firmly holding braking mechanism 4 is formed by two vertical plates 14, 15, wherein the upper end of said plate 14 has an upward extruded part 141 with a small hole 142 for the upper end of said hook 53 to insert through, and then, to insert into said long shaped furrow 51; the lower end of said upward extruded part 141 then has an aperture 143 for the lower end of said hook 53 to insert into said heart-shaped furrow 52 through the aperture 143.

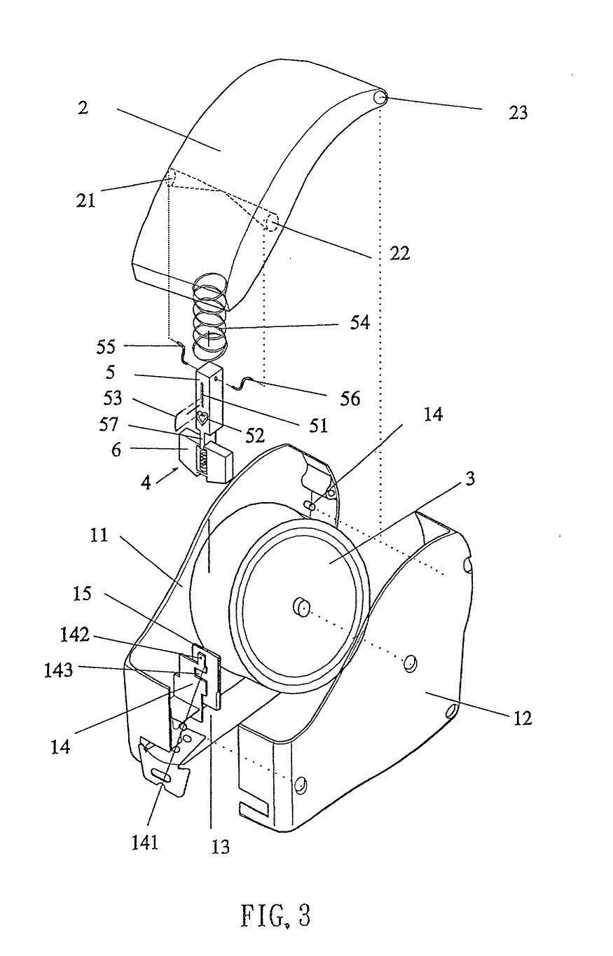

As shown in FIG. 5, said heart-shaped furrow 52 is formed as a guiding path, such that the lower end of said hook 53 is moved only in counter-clock direction or clock direction, and stops at position A or B to determine the condition of braking.

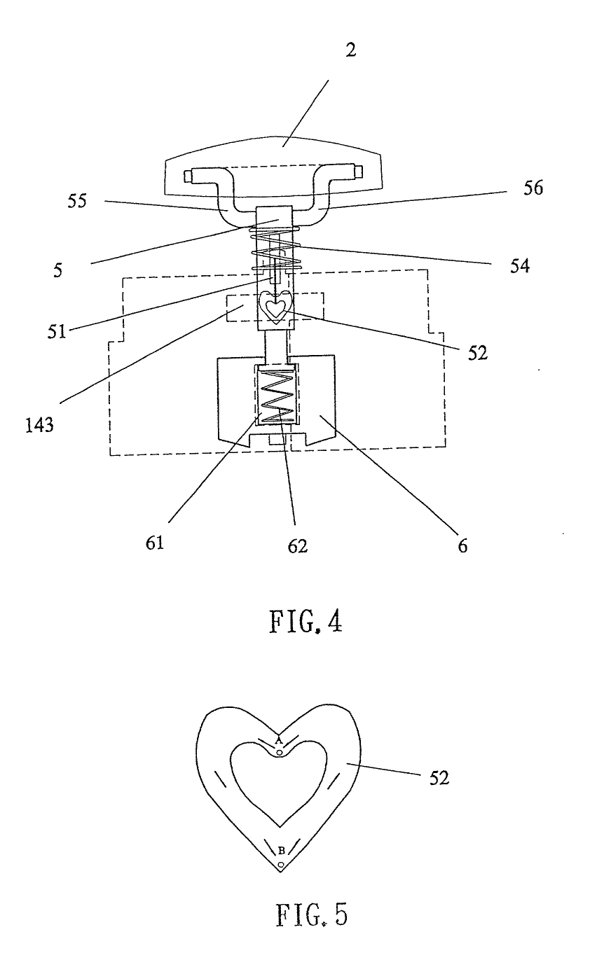

In composition, as shown in FIG. 6, when the upper cover 2 is not pressed downward, the button surface of base 6 keeps apart from tape rule 3 a small distance, and the lower end of hook 53 stops at position B.

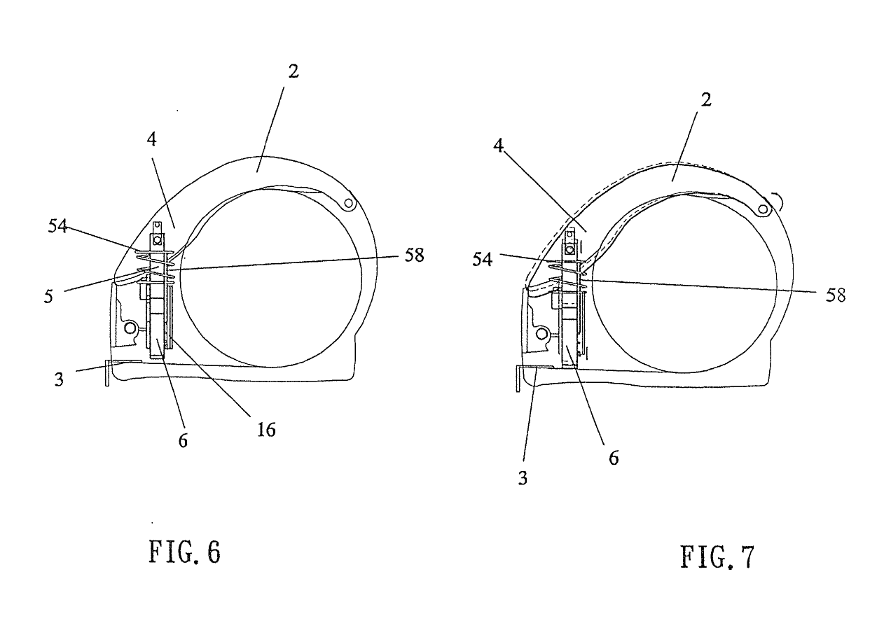

As shown in FIG. 7, when the upper cover 2 is pressed downward, the ears 55, 56, the stem 5 and the second spring 62 then moves downward; when the stem 5 move downward, the first spring 54 is then in a compressive condition and a rebound force is produced; at the same time, the hook 53 is fixly located because its upper end is inserted into said small hole 142, its lower end would then follow the heart-shaped furrow 52 and move to position A; the second spring 62 inside the base 6 then is depressed by pressing plate 57 and its rebound force is produced. As a result, the base 6 moves downward to depress the tape rule 4 and the movement of tape rule 4 is suspended.

When the upper cover 2 is pressed downward again, the above actions are repeated, expect the lower end of hook 53 moves from position A to B along the path of heart-shaped furrow 52, after the downward movement and upward movement of the stem 5. Then the base 6 is not depressed, and the depression of base 6 to tape rule 4 is released.

In addition to the above braking action, the upper cover 2 can be pressed to the lowest position and maintained at its lowerest position, then the movement of tape rule is temporarily suspended.

Furthermore, in order to enable the stem 5 to smoothly move upward and downward, there is an extruded branch 58 formed onto the back surface of the stem 5, and a narrow aperture 16 for holding said extruded branch 58 is formed onto said vertical plate 15 forming a vertical space 13 for holding braking mechanism 4. Thus, the braking mechanism would smoothly moves when it is depressed.

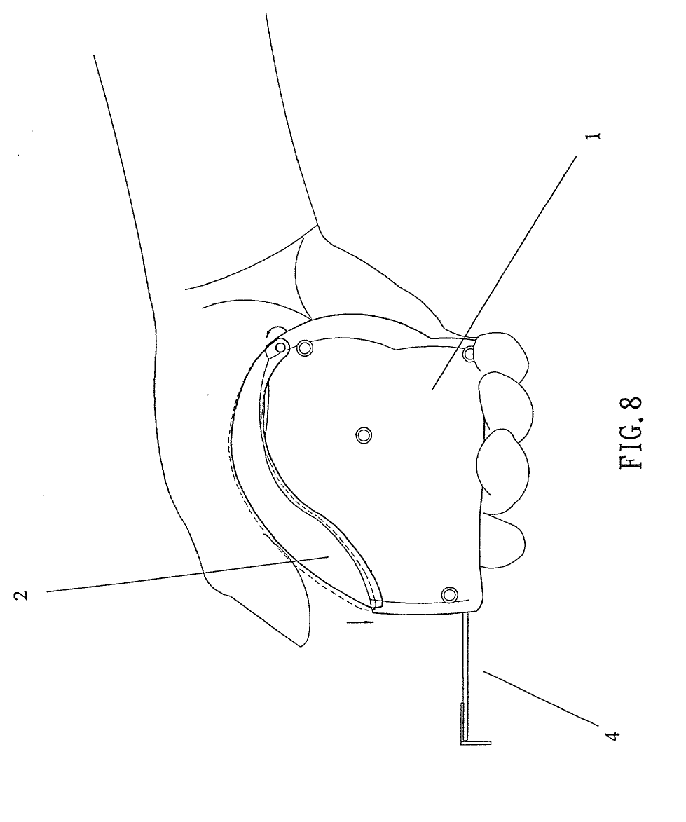

It can be understood that, according to the construction of present application, the movement of tape rule can be suspended simply by pressing the upper cover 2 of the housing 1 to move downward, and the upper cover 2 of the housing 1 can be pressed downward by people's hand, rather than by people's thumbs. It is then an energy-saving measuring tape. The outline of present invention can be seen from FIG. 8, and it can be designed as a smooth and complete measuring tape.

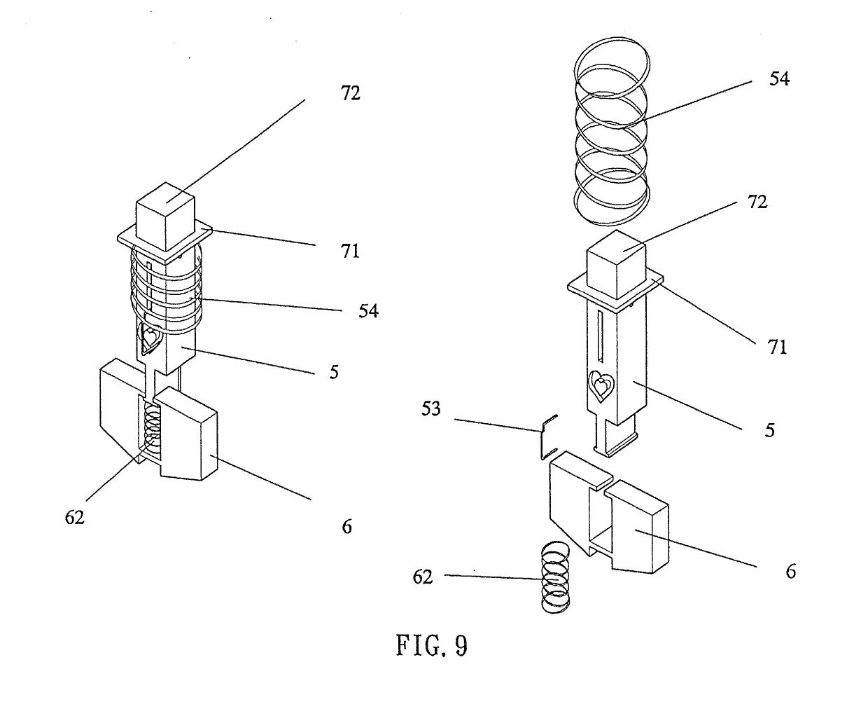

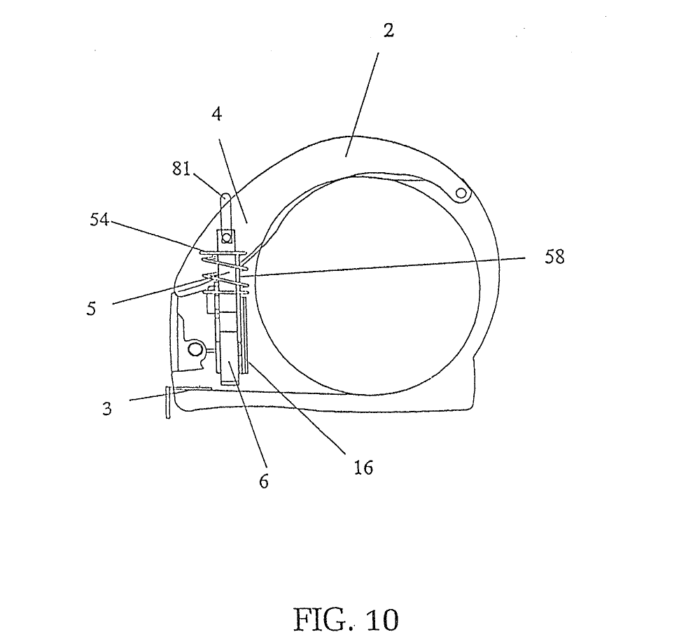

According to the structure of the measuring tape of present invention, as shown in FIG. 9, the upper part of stem 5 can be formed of a flange 71, on the flange, there is an extruded pole 72 extends into to the upper cover 2 of the housing 1, then the braking mechanism 4 can be pressed downward by the upper cover 2.

According to another example of the structure of the measuring tape of present invention, as shown in 10, on the upper cover 2 of the housing, a hole is formed for said extruded pole 8 of the stem 5 of the braking mechanism 4 to insert through, then people can directly push the extruded pole 8 to control the movement of tape rule 3, and the suspension of the movement of tape rule of measuring tape is achieved.

Accordingly, from the aforementioned description, the braking structure of measuring tape of present invention of the present invention certainly has the effect of sustaining the tape rule in a steady condition. Although the present invention has been described using a specified embodiment, the examples are meant to be illustrative and not restrictive. It is clear that many other variations would be possible without departing from the basic approach, demonstrated in the present invention.

What is claimed is:

1. A breaking structure of measuring tape, including a housing, a tape rule contained in the housing and a braking mechanism, characterized in that: a push button is formed onto the housing, by pushing the push button into the housing to keep it at a lower position; a base stopper of the braking mechanism would effectively suspend the movement of the tape rule, and after that, if the pushed button is push downward again, the braking mechanism would push the push button upward and return to its higher position, then the base stopper of the braking mechanism would separate the tape rule and the movement of the tape rule would not be suspended.

2. A breaking structure of measuring tape, as claimed in claim 1, wherein said push button is the upper cover of the housing, said upper cover is rotationably fixed with the housing at its one end; then the upper cover of the housing can be pressed downward.

3.A breaking structure of measuring tape, as claimed in claim 1, wherein said push button is the upper end of the stem of braking mechanism, which inserts through a hole formed on the upper cover of the housing.

4. A breaking structure of measuring tape, as claimed in claim 1, wherein said braking mechanism is installed into a space inside the housing; it includes a stem and a base; a vertical long-shaped arrow is formed on the body of the stem; under the long-shaped furrow, a heart-shaped furrow is formed; between the said long-shaped furrow and said heart-shaped furrow, there is a [symbol] -shaped hook with its two ends respectively insert into said long-shaped furrow and heart-shaped furrow; the upper section of hook is held by a first spring mounted onto the stem, and the upper end of the first spring is stopped by two ears installed at the upper end of the stem; the ends of said two ears are put into a pair of furrows formed at the upper cover; the lower end of said stem is formed with a pressing plate, which is extruded into the inner space of said base to press a second spring installed inside the base; when the stem is pressed downward by said upper cover, then said second spring inside said base is depressed and the base is moved downward by the rebounding force of said second spring to press against the upper surface of tape rule, and then movement of tape rule is suspended.

5. A breaking structure of measuring tape, as claimed in claim 4, wherein the vertical space formed inside the housing for firmly holding braking mechanism is formed by two vertical plates, wherein the upper end of a vertical plate has an upward extruded part with a small hole for the upper end of said hook to insert through, and then to insert into said long-shaped furrow; the lower end of said upward extruded part of a vertical plate then has an aperture for the lower end of said hook to insert into said heart-shaped furrow through the aperture.

6. A breaking structure of measuring tape, as claimed in claim 4, wherein said heart-shaped furrow is formed as a guiding path, such that the lower end of said hook is moved either in counter-clock direction, and stops at an upper concave position or lower concave position to determine the braking condition.

7. A breaking structure of measuring tape, as claimed in claim 4, in order to enable the stem to smoothly move upward and downward, there is an extruded branch formed onto the back surface of the stem, and a narrow aperture for holding said extruded branch 58 is formed onto said vertical plate forming a vertical space for holding braking mechanism.

8. A breaking structure of measuring tape, as claimed in claim 4, the upper part of stem can be formed of a flange, on the flange, there is an extruded pole extends into to the upper cover of the housing, then the braking mechanism can be pressed downward by the upper cover.
